(19) United States
(12) Patent Application Publication
(10) Pub. No.: US 2025/0224323 A1
(43) Pub. Date: Jul. 10, 2025

(54) Methods and Apparatus for Dynamically Determining the Permeability of a Porous Solid

(71) Applicant: Micromeritics Instrument Corporation, Norcross, GA (US)

(72) Inventors: John McCaffrey, Duluth, GA (US); Daniel J. Rockwell, Media, PA (US); Abhijit Jayakumar, Atlanta, GA (US); Elijah Dufty, Atlanta, GA (US); Michael Beckert, Atlanta, GA (US); Jeff Kenvin, Roswell, GA (US); Krishna Murari Gupta, Duluth, GA (US); Paul Bracher, Suwanee, GA (US)

(21) Appl. No.: 19/009,531

(22) Filed: Jan. 3, 2025

Related U.S. Application Data
(60) Provisional application No. 63/617,962, filed on Jan. 5, 2024.
(60) Provisional application No. 63/713,808, filed on Oct. 30, 2024.

(51) Int. Cl. G01N 15/08

(52) U.S. Cl. CPC G01N 15/0806; G01N 15/0826; G01N 15/088

(57) ABSTRACT

A method and apparatus for dynamically adjusting pressure ramping to maximize determination of capillary porosity resolution of a porous material. The method dynamically increases pressure ramp rate applied to a wetted sample as rate of mass flow change decreases and dynamically decreases pressure ramp rate as rate of mass flow change increases. The method can further control the pressure ramp sensitivity to changes in mass flow rate and can apply a resolution parameter to control the rate of pressure change.

### CROSS REFERENCE

The present Patent application claims the benefit of U.S. Provisional Patent Application No. 63/617,962, filed Jan. 5, 2024, and claims the benefit of U.S. Provisional Patent Application No. 63/713,808, filed Oct. 30, 2024.

### INCORPORATED BY REFERENCE

The disclosures made in U.S. Provisional Patent Application No. 63/617,962, filed Jan. 5, 2024, and U.S. Provisional Patent Application No. 63/713,808, filed Oct. 30, 2024 are specifically incorporated by reference herein as if set forth in their entireties.

### FIELD OF THE INVENTION

The present subject matter relates in general, to the field of porometry, or the measurement of the porosity of substances. In particular, the present disclosure relates to a method of determining pore size and pore size distribution of a porous material using a wetting fluid to pass through pores as a function of a driving variable, and embodiments of an apparatus for use in the methodology.

### BACKGROUND OF THE INVENTION

In the field of porometry, pore size and pore size distribution of a sample of a porous material can be measured under control of pressure and mass flow. When a sample is dry, all of the pores are empty so the gas flows proportionally to the amount of pressure being added. After wetting the sample, the pores are all filled with the wetting fluid such that the gas does not flow through the blocked pores. However, as the pressure increases, pores are opened as wetting fluid is forced through the sample. Pores with larger effective diameters are opened at lower pressures than pore with smaller effective diameters. The passage of a gas flow through the largest pore(s) is the bubble point of the sample. The pores in the sample continue to empty out as the pressure continues to increase, until all of the pores have been emptied. The pore distribution of the sample is calculated using the ratio between the wet and dry flow measurements.

In conventional capillary flow porometry analysis, a sample is fully wetted using a fluid with a known surface tension and pressure is applied via pressure ramping or pressure stepping to the sample to identify the first bubble point. The process continues by increasing pressure until all the pores in the sample are opened, which is shown as the wet curve. Pressure can subsequently be reduced until no flow is detected, which defines the dry curve and which can be either a dry up or dry down curve as shown in the figures. In general, two methods for capillary flow porometry testing of samples have traditionally been used, pressure ramping and pressure stepping.

In conventional pressure ramping, the pressure increases continuously at a constant rate. This provides for a fast and reproducible method that is generally recommended for quality control work and for samples with identical pores. It is problematic however that that when the sample has a complex structure with a considerable amount of pores of different tortuosity, it is possible that during the constant pressure ramp up pores with the same diameter but longer or more tortuous pore paths are not emptied at the pressure that corresponds to their respective diameter. In this instance, if the pressure ramp up is fast there is insufficient time to allow the gas flow to displace the wetting liquid through the pore length. Resultingly, pores with longer pore length will be reported as having smaller pore sizes than their actual size. Thus, while this pressure ramping method is faster than the conventional pressure stepping method, it can suffer from reduced resolution, particularly in tortuous test samples where pores of similar size have different and time dependent flow paths.

In conventional pressure stepping, the pressure increases in a series of predetermined step increases, which includes a stabilization period after each respective step. As will be appreciated, the stabilization period helps to minimize errors induced by a sample's differing tortuosity and pore length of pores with the same diameter. In this method, measurements are typically acquired after holding the pressure constant for a predetermined period of time and waiting for gas flow through the sample to stabilize, which allows sufficient time for the gas flow to displace the wetting liquid in longer, more tortuous, pores of the same diameter. The pressure step method combined with controlled flow further allows for the measurement of the true first bubble point, compared to the pressure ramping method, which only permits calculation of the first bubble point at measured flow rates. The conventional pressure step, stabilize and measure method requires an undesired compromise between measurement resolution and overall test time. Small pressure step sizes across the pressure range generally yield higher resolution while taking a commensurately longer time to complete. Conversely, large pressure step sizes across the pressure range most often yield lower resolution while taking shorter time to complete.

Conventional methodologies require trades offs between resolution and overall test time to help achieve measurement objectives. Thus, there is a need in the art for a method and apparatus that increases the speed of obtaining a high-resolution determination of capillary porosity of a porous material.

### SUMMARY

Aspects and advantages of the invention will be set forth in part in the following description, or may be obvious from the description, or may be learned through practice of the invention.

Embodiments of the inventive concepts disclosed herein are directed to methodologies and apparatus for determining a porous sample's capillary flow porosity by monitoring and controlling applied pressure according to changes measured to the pore size and pore size distribution of the porous material sample under test, based on user programable parameters, and maximum and minimum limits. This is in part determined by applying pressure across a porous material sample under test and the mass flow of gas through the porous material sample.

The methodology described herein reduces the time required to determine the pore size and pore size distribution of the porous material sample while enhancing the resolution of the measurement. In embodiments, the methodology described herein uses pressure ramping to enable rapid measurements and that dynamically slow the increase of the pressure ramp to approach a constant pressure as a function of gas flow rate change. The achieved slower pressure increase and near constant pressure enables the determination of the porosity of the sample with high resolution. This method is designed to minimize test time while enhancing resolution in capillary flow porometry.

The methodology described herein dynamically adjusts the pressure ramping to maximize resolution during pore openings. That is, the method dynamically increases pressure ramp rate as rate of mass flow change decreases and dynamically decreases pressure ramp rate as rate of mass flow change increases. Optionally, and to further enhance the resolution of the porosity measurements, user parameters can be applied to control the pressure ramp sensitivity to changes in mass flow rate, and a resolution parameter can be used to control the rate of pressure change.

In one example, the applied testing pressure ramp is modified in an exponential form and can be controlled between a defined minimum and maximum pressure ramp rate. In this aspect, a maximum pressure ramp can be applied when rate of change of mass flow is constant and can approach zero when rate of change of mass flow increases.

In this method, the applied pressure rate can be dynamically adjusted based on a set of user adjustable parameters including at least one of a maximum pressure ramp rate, a resolution parameter that controls ramp rate deacceleration, and a sensitivity parameter that controls how sensitive the rate of pressure change is to changes in the gas flow rate.

Still other aspects, embodiments, and advantages of these exemplary aspects and embodiments, are discussed in detail below. Moreover, it is to be understood that both the foregoing information and the following detailed description are merely illustrative examples of various aspects and embodiments and are intended to provide an overview or framework for understanding the nature and character of the claimed aspects and embodiments. Accordingly, these and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain the principles of the embodiments discussed herein. No attempt is made to show structural details of this disclosure in more detail than can be necessary for a fundamental understanding of the exemplary embodiments discussed herein and the various ways in which they can be practiced. According to common practice, the various features of the drawings discussed below are not necessarily drawn to scale. Dimensions of various features and elements in the drawings can be expanded or reduced to illustrate the embodiments of the disclosure more clearly.

FIG. 1 is a schematic showing an example of the wetting of a sample and the wetting angle for the Washburn equation.

FIG. 2 shows schematic cross-sections of a sample with wetted and opened pores.

FIG. 3 shows an exemplary tortuous flow path lengths through a porous material sample.

FIG. 4 is a schematic illustration of one embodiment of the apparatus.

FIG. 5 is a schematic illustration of one embodiment of the apparatus.

FIG. 6 is a schematic illustration of one embodiment of the apparatus showing a control subsystem.

FIG. 7 shows a schematic flow chart for dynamically determining a pressure ramp rate.

FIG. 8 illustrates an example of pressure vs. flow rate analysis using embodiments of the methodologies of the present disclosure.

FIG. 9 illustrates example pore size determinations.

FIGS. 10A-10D are graphs of gas flow through a sample assuming Quasi-Steady behavior, that the linear ramp rate is 0.05 psi/s, that the surface tension of the wetting agent is 16.3 dyn/cm, that the contact angle is 0 deg, that the sampling rate is 10 Hz, that the final pressure is 500 psig, and that the initial pressure is 0.019 psig. As shown, conventional linear pressure ramping (blue lines) is too “fast” for large pores in a sample while being conversely too “slow” for small pores in the same sample while the dynamic and exponential pressure stepping methodology (red lines) provides a faster overall determination of porosity and allows for substantially the same uncertainty (i.e., error in measurement divided by pore size) in each pore measurement across the entire range of pore sizes. As shown, the dynamic and exponential pressure stepping methodology takes smaller or larger steps in pressure where appropriate (when measuring small pores, large pressure steps can be taken and when measuring large pores, small pressure steps can be taken).

FIG. 11 graphically illustrates time series data results for an exemplary 1.0 um nominal pore size thin filter sample using a 0.2 psi/second linear ramp modality showing applied T1 pressure (psig), flow (slpm), and flow/pressure, and showing derived wet up, dry down, and dry up cycles.

FIG. 12 graphically illustrates the time series data of FIG. 11 converted into a flow versus pressure plot showing applied T1 pressure (psig), flow (slpm), and flow/pressure.

FIG. 13 graphically illustrates the time series data of FIG. 11 converted into a flow/pressure versus pore size pressure plot. This plot conversion from pressure to pore size assumes a contact angle of zero for and tortuosity of 1.0 (which for the given wetting fluid surface tension results in pore size=9.1/pressure, where pressure is in psig).

FIG. 14 graphically illustrates the flow/pressure versus pore size pressure plot data of FIG. 13 converted into a slope vs pore size plot, in which the slope is the slope of the respective flow/pressure data points of FIG. 13, and graphically showing the pore size of the sample gathered about a 0.76 μm pore size.

FIG. 15 graphically illustrates time series data results for an exemplary filter sample having two discrete pore sizes. The plot was derived by using a 0.2 psi/second linear ramp modality showing applied T1 pressure (psig), flow (slpm), and flow/pressure.

FIG. 16 graphically illustrates the time series data of FIG. 15 converted into a slope vs pore size plot, in which the slope is the slope of the respective determined flow/pressure data points derived from FIG. 15, and graphically showing the pore sizes of the sample gathered about respective 1.375 and 2.645 μm pore sizes.

FIG. 17 graphically illustrates a flow versus pressure plot data results for an exemplary 0.05 μm nominal pore size thin filter sample using a 0.2 psi/second linear ramp modality showing applied T1 pressure (psig), flow (slpm), and flow/pressure.

FIG. 18 graphically illustrates a flow versus pressure plot data results for an exemplary 12.0 μm nominal pore size thin filter sample using a 0.2 psi/second linear ramp modality showing applied T1 pressure (psig), flow (slpm), and flow/pressure.

FIG. 19 graphically illustrates a flow versus pressure plot data results for an exemplary 1.0 μm nominal pore size thin filter sample using a 0.2 psi/second linear ramp modality showing applied T1 pressure (psig), flow (slpm), and flow/pressure.

FIGS. 20A and 20B show embodiments of sample adaptor plates having a plate member configured with a central well that is operatively sized and shape to receive a porous test sample, such as the exemplarily shown woven test mesh filter samples.

FIG. 21 shows an embodiment of a sample adapter plate showing a plate member having central well configured to operatively receive a woven test mesh filter sample positioned in stacked relationship to a lower fine mesh screen and an O-Ring to seal the well for testing. Also shown is an optional coarse screen.

FIG. 22 shows an embodiment of a test stack profile for positioning therein the well of an adapter plate. In this embodiment, the test stack comprises a woven test mesh filter sample positioned therebetween an upper fine mesh screen and a lower fine mesh screen. Biasing means are applied, such as by an O-Ring, to ensure that the formed test stack is placed into compression so that the fibers forming the woven test mesh filter sample are compressed together to form a test sample with a more uniform porosity.

FIGS. 23A and 23B show photomicrographs of exemplary woven test filter sample. FIG. 20A shows a photomicrograph of a 70 μm woven mesh filter (measured 65 μm) and FIG. 20B shows a photomicrograph of a 53 μm woven mesh filter (measured 50 μm).

FIGS. 24 and 25 graphically show the results of testing of an exemplary test stack profile as shown in FIG. 22. In this example, a 53 μm woven test mesh filter sample was positioned between identical upper and lower fine mesh screes formed with (250 μm holes). As shown, the test was run multiple times with the wetted sample test “A” and multiple replicate runs (“B”, “C”, “D”, “E”) without rewetting. As shown by “A,” placing the exemplary test stack profile shown in FIG. 18 results in a significantly smaller FBP/BP, with excellent precision (0.1-0.2% RSD).

FIGS. 26 and 27 graphically show the results of testing of an exemplary test stack profile as shown in FIG. 22. In this example, a 70 μm woven polyester test filter sample was positioned between identical upper and lower fine mesh screens formed with (250 μm holes). As shown, the test was run multiple times with the wetted sample test “A” and multiple replicate runs (“B”, “C”, “D”, “E”) without rewetting. As shown, the test with 70 μm polyester mesh, with sample plates (250 μm holes) positioned above and below the test mesh filter showed tight grouping of FBP and BP (0.1-0.2% RSD). In addition, in the exemplary sample test, the bubble point pore size (average: 95.03 μm) was closer to that calculated from the thread diameter and pitch (103.02 μm) than to the nominal manufacturer pore size (70 μm).

FIG. 28 shows an embodiment of a sample adjustable sample plate assembly that is configured to receive a test filter sample that have a relatively thick height and showing an articulating or sliding seal assembly that is configured to assert bias pressure to assure proper operative seating of an O-Ring against the peripheral edge of the test filter sample within the test well of the sample plate assembly.

FIG. 29 shows an embodiment of a sample chamber showing a cap that is configured to be threadedly coupled to a first flow line that is in fluid communication with the inlet side of the sample chamber and showing the cap being configured to be threadedly coupled to a complementarily threaded throat that is in fluid communication with an interior volume of the sample chamber into which the wetted pore sample can be mounted for testing.

FIGS. 30A-30D show one embodiment of a cap that defines at least one cap grove that extends from a distal edge of the threaded portion of the cap to proximate a lower surface of a top member. As further shown, the at least one cap groove is spaced from the termination of the thread near the lower surface of the top member.

FIGS. 31A-31D show one embodiment of a throat having a circumferential wall that extends from a top surface of a bottom member of the throat proximate a circumferential edge of the bottom member and extends distally therefrom substantially transverse to a plane of the bottom member. As shown, the throat can define at least one throat grove that extends from a proximal edge of the threaded circumferential wall portion of the throat to proximate the top surface of the bottom member.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a pore” can include two or more such pores unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It should be appreciated, that as used herein, terms of approximation, such as a “about” or “approximately,” refers to being within 10% margin of error.

As used herein, the terms “optional” or “optionally” mean that the subsequently described event or circumstance can or cannot occur, and that the description includes instances where said event or circumstance occurs and instances where it does not.

As used herein, the term “first bubble point” means the pressure at which the displacement fluid starts to flow through a pore in a porous material sample.

As used herein, the term “wet curve” is the representation of the measured gas flow through a wet sample against the applied pressure.

As used herein, the term “dry curve” is the representation of the measured gas flow through a dry sample against the applied pressure.

As used herein, the term “tortuosity” denotes the deviation from a straight path described by pore geometry, e.g., turns, multiple narrowing's of pore diameter along its length and branching of through pores all contribute to tortuosity.

As used herein, the term “pore size” means the operative width between two opposite walls of the pore.

As used herein, the term “pore size distribution” refers to the statistical distribution of the pore sizes in the sample, where the radius of the equivalent biggest sphere that can be fitted into a through-pore at a narrowest point defines the size of a pore.

As used herein, the term “differential pressure” refers to the pressure difference between applied pressure and ambient pressure on either side of tested porous sample.

The word “or” as used herein means any one member of a particular list and also includes any combination of members of that list. Further, one should note that conditional language, such as, among others, “can,” “could,” “might,” or “can,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular embodiment.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

Disclosed are components that can be used to perform the disclosed methods and apparatus. These and other components are disclosed herein, and it is understood that when combinations, subsets, interactions, groups, etc. of these components are disclosed that while specific reference to each various individual and collective combinations and permutation of these cannot be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and apparatus can be understood more readily by reference to the following detailed description of preferred embodiments and the examples included therein and to the Figures and their previous and following description.

Embodiments of the inventive concepts disclosed herein are directed to methodologies and apparatus for determining a porous material sample's capillary flow porometry by monitoring and controlling applied pressure according to changes measured to the pore size and pore size distribution of the porous material sample under test, based on user programable parameters, and maximum and minimum limits. This is in part determined by applying pressure across a porous material sample under test and the mass flow of gas through the porous material sample. Example embodiments of the methodologies and apparatus are described below with respect to the figures.

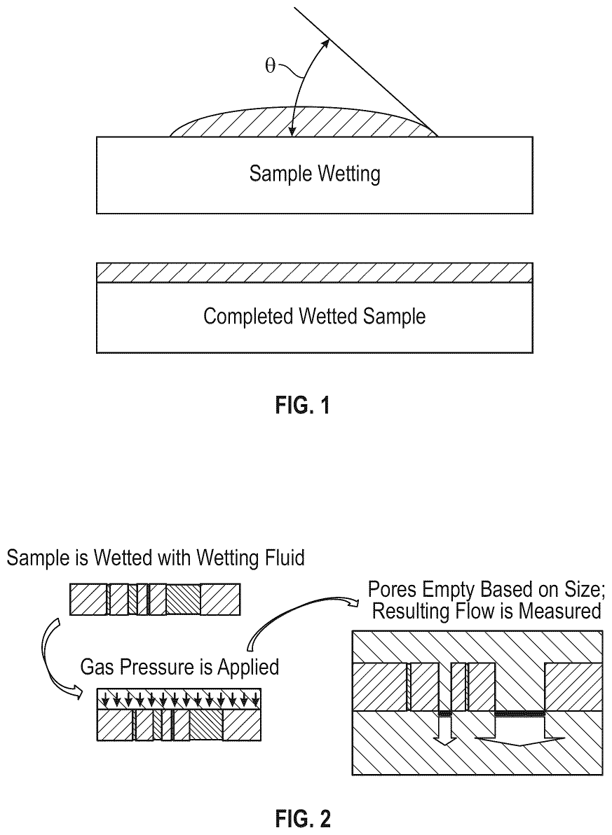

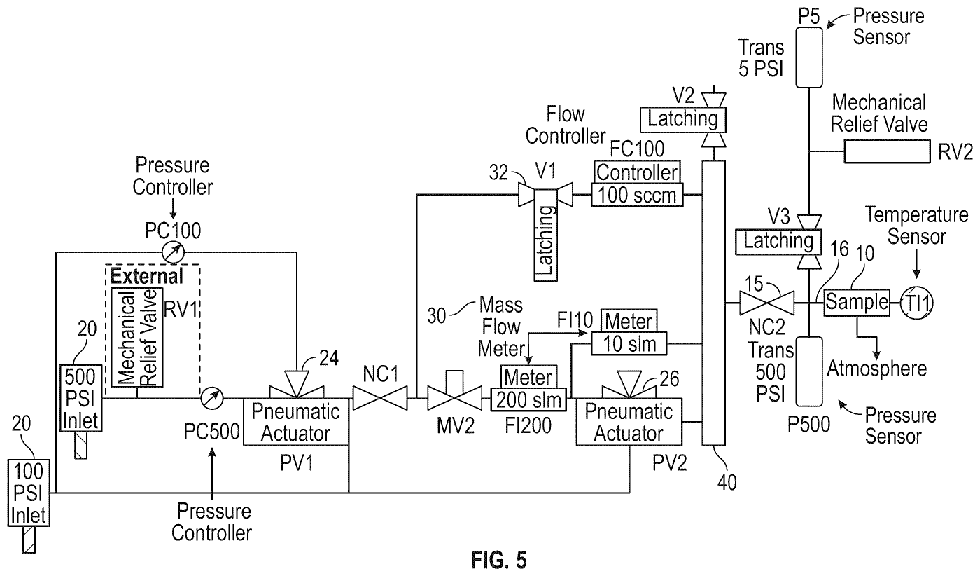

Referring to FIG. 1, an example of a wetting fluid being applied to a sample is shown. The wetting fluid generally can include various types of fluids having a known surface tension and is spread evenly across sample to achieve a zero degree contact angle as indicated in FIGS. 1 and 3. One skilled in the art will appreciate that “contact angle” does not simply mean “spread evenly across a surface,” rather it is indicative of the wettability of a solid sample by a liquid.

Thereafter, in embodiments such as shown in FIG. 3, as gas is applied under pressure to the fully wetted sample, the wetting fluid is forced through the sample. As further indicated in FIG. 3, the pores will empty based on pore size, with the largest pore(s) emptying first. In embodiments, the detection of a drop in gas pressure, indicating that gas has passed through the largest pore(s) is the bubble point of the sample (when mass gas flow is controlled). The bubble point generally is established by beginning with a sample material that is saturated with a wetting agent and subsequently increasing gas pressure to the upstream side until capillary forces are overcome and gas flow or decrease in gas pressure (when mass gas flow is controlled) can be measured.

At the bubble point, the largest pore empties first, which defines the Max Pore Size. Based on the known Laplace equation of capillary pressure, the diameter of the largest pore-throat can be calculated once the bubble point is determined. As one can appreciate, at higher and higher pressures, smaller and smaller pores empty and the resulting increases in gas flow are measured.

Based on the further application of pressure, a range of the pore sizes for the sample can be computed using an idealized Washburn equation that assumes a tortuosity of 1 and cylindrical pore shapes of the same length, which is defined as follows:

$$Δ P = 4 * γ * cos θ / D$$

where:
   ΔP—is applied pressure (bottom side of sample is to atmospheric pressure);
   D—is the diameter of the most constricted part of pore;
   γ—is the surface tension of the air-liquid interface; and
   θ—is the wetting angle with solid matrix of the membrane.

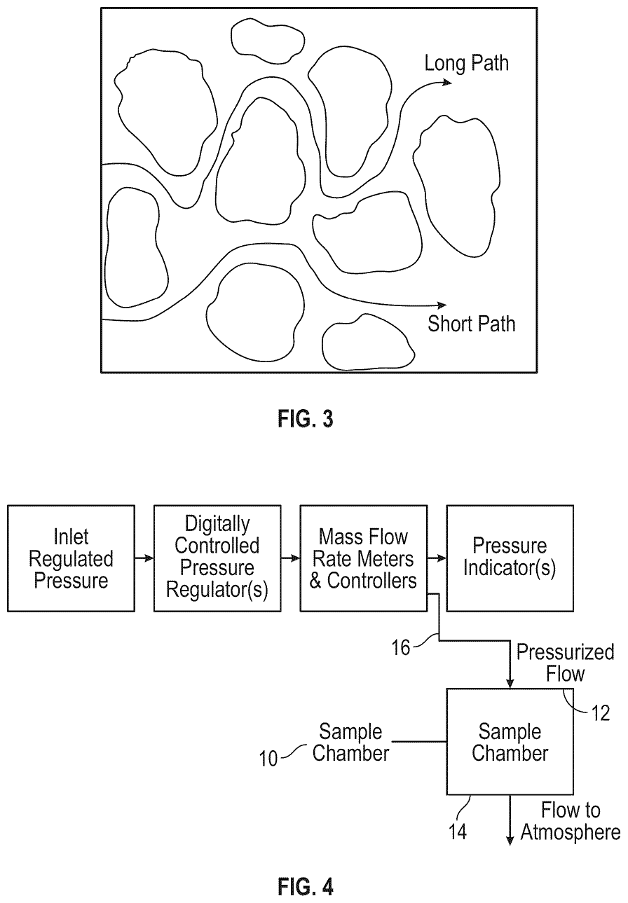

While FIG. 2 illustrates a more straight-line flow of pressurized gas through a sample, in most cases, and particularly for thicker samples, the flow paths for the gas through the sample will not be a straight-line, but rather will become more tortuous. For example, as shown in FIG. 3, when gas flows through a porous material it generally can encounter branches and paths of various lengths and throat sizes. Resultingly, the time it takes for gas to pass through the material, even when equal pore sizes, will vary. As one will appreciate, turns, multiple narrowing of pore diameter along its length and branching of through pores all contribute to a sample's tortuosity, but the measured pore size is the size of the narrowest throat restriction along the tortuous path. Tortuosity is the deviation from a straight path through the sample described by pore geometry. However, the Washburn equation assumes a perfect cylindrical shape for each path. An empirically derived shape factor can therefore be applied to correct for tortuosity and shape; giving the following enhancement to the Washburn equation with θ consider to be 0 degrees and cos θ=1:

$$D = 4 * S * γ / Δ P$$

where:
   S—is an empirically derived shape factor.

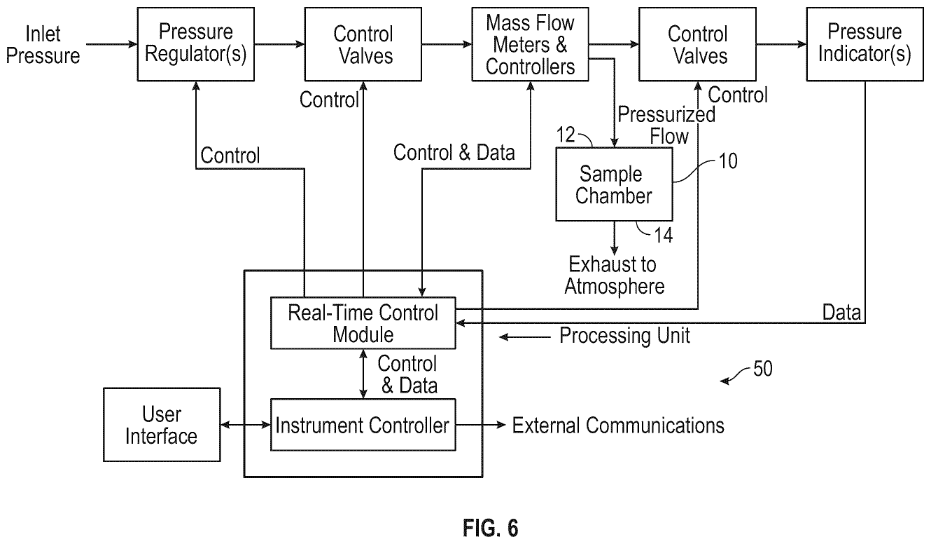

Referring to FIG. 4, an example embodiment of an apparatus according to the invention is configured to measure permeability of the solid sample. The apparatus comprises a sample chamber having an interior volume that includes a sample holder for holding a porous solid sample for the duration of the experimental procedure. The interior volume of the sample chamber defines an inlet side and an outlet side, which sides are separated by the sample holder. The apparatus comprises a first flow line in fluid communication with the interior volume of the inlet side of the sample chamber. The interior volume of the outlet side of the sample chamber is in fluid communication with the atmosphere. The first flow line has a first valve disposed in it.

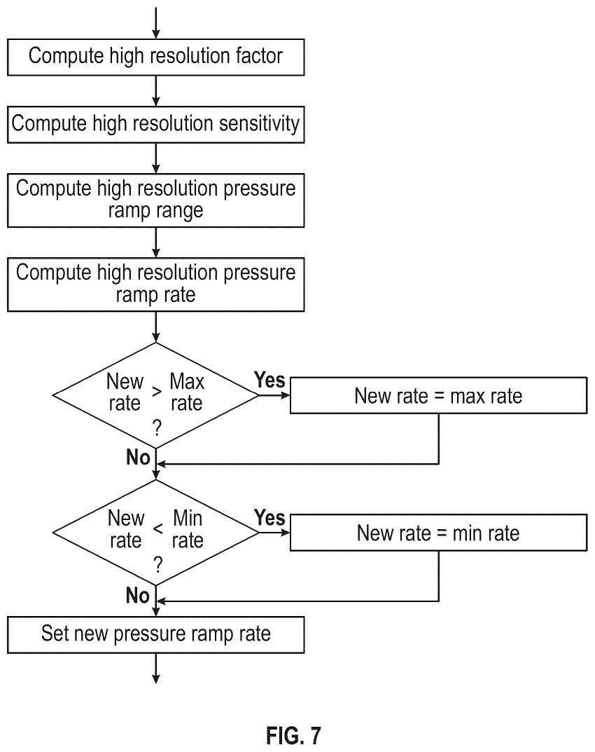

As exemplarily illustrated and referring to FIG. 5, the first flow line is in fluid communication with a plurality of gas sources, such as, without limitation, the exemplified 100 and 500 psi gas sources and a plurality of pressure measuring devices or sensors, in the form of pressure transducers, which can have differing pressure sensitivity. The respective application of gas from the respective plurality of gas sources is controlled by the use of first and second pressure regulators (actuators). The first pressure actuator is downstream of and in fluid communication with the plurality of gas sources and is in fluid communication with the downstream second pressure regulators. The first pressure regulator is also in fluid communication with a plurality of flow meters and a flow controller. As exemplarily illustrated, the plurality of flow meters, the flow controller, and the second pressure regulator are in fluid communication with a common manifold that is positioned upstream and in fluid communication with the first valve of the first flow line.

Referring to FIG. 5, in embodiments, the apparatus is intended to regulate the inlet pressure of the chamber and allows for the dynamic control of pressurized gas to be applied to the target sample within the chamber as well as allowing for the dynamic control of the mass flow rate of gas being supplied as a pressurized flow of the gas to the target sample.

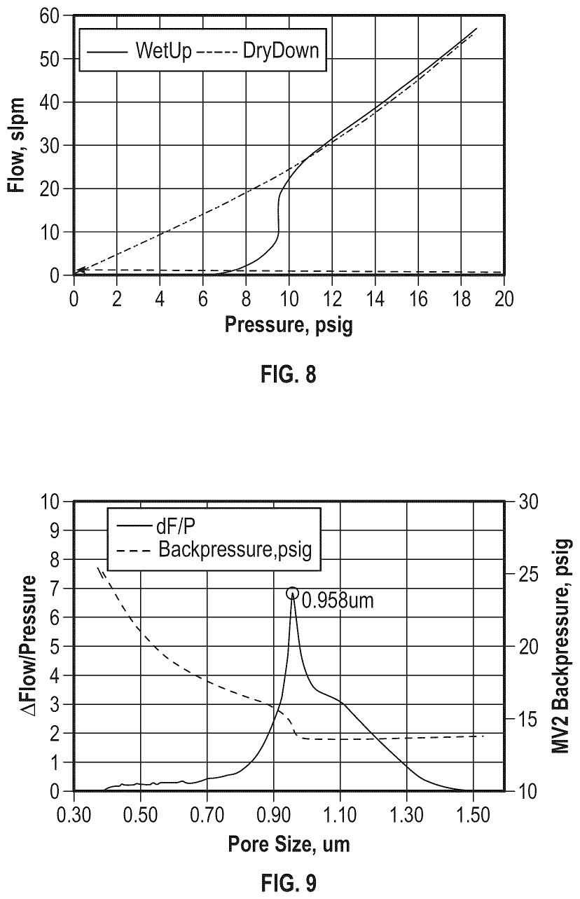

In one aspect and with reference to FIG. 6, the apparatus can be configured to house a control subsystem which can be configured to contain the electronic controls, computer systems, programing, etc. necessary for operation of the apparatus. Thus, in this aspect, it is contemplated that the control subsystem of the apparatus can include a processing system having a control module and an instrument controller that includes at least one processor and at least one memory, which can be coupled to a volatile or non-volatile memory containing a database for storing information related to the operation of the apparatus. The memory being configured to contain instructions that, when executed by the processor, are operative to perform the essential, recommended and/or optional functions in various embodiments of the apparatus described herein. In this aspect, the control subsystem has at least one memory that is configured to store program instructions such that, in operation, at least one memory of the control subsystem is configured to store program instructions that, when executed, cause the apparatus to perform the required operations.

To regulate the operation of the apparatus, the control subsystem can include input devices (such as a selected one of the pressure transducers, which can be a high pressure transducer (500 psi) or a low pressure transducer (5 or 25 psi), and mass flow meters) and output devices (such as pressure regulators, mass flow controllers, and control valves) that are operatively coupled to the processor(s). In embodiments, the control subsystem is configured to allow for a real-time control and is in operative communication and control of the first and second pressure regulators, the system control valves, and the mass flow meters and controllers.

In exemplary aspects, the control subsystem is configured to receive data from the mass flow meters on respective mass flow rates of the supplied pressurized flow and to receive data from the pressure measuring devices on the sensed gas pressure. The control subsystem includes a memory that is in communication with the processor(s) and may also include other features such as limiters, conditioners, filters, format converters, or the like which are not shown to preserve clarity. One or more operator input devices can also be coupled to the instrument controller to provide corresponding operator input to adjust/direct one or more aspects of apparatus operation. Exemplary input devices can include, without limitation, a keyboard, mouse, pen, voice input device, gesture input device, and/or touch input device, or any other suitable input device. The control subsystem can further include one or more output devices that are coupled to the instrument controller, such as a display, printer, and/or speakers, or any other suitable output device. In other embodiments, however, computer-readable communication media may include computer-readable instructions, program modules, or other data transmitted within a data signal, such as a carrier wave, or other transmission. Optionally, the control subsystem can also include an audible alarm, warning light(s), or the like (not shown) can also be coupled to the controller that each respond to various output signals from controller.

In additional detail, the control subsystem is configured for implementing certain systems and methods for operating an apparatus in accordance with certain embodiments of the disclosure. The processor(s) is configured to execute certain operational aspects associated with implementing certain systems and methods described herein. The processor(s) can be implemented and operated using appropriate hardware, software, firmware, or combinations thereof. Software or firmware implementations may include computer-executable or machine-executable instructions written in any suitable programming language to perform the various functions described. In some examples, instructions associated with a function block language may be stored in the memory and executed by the processor(s).

As one will appreciate, the memory can be used to store program instructions, such as instructions for the execution of the methods illustrated herein or other suitable variations. The memory can include, but is not limited to, an operating system and one or more application programs or services for implementing the features and embodiments disclosed herein. The instructions are loadable and executable by the processor(s) as well as to store data generated during the execution of these programs. Depending on the configuration and type of the control subsystem, the memory may be volatile (such as random-access memory (RAM)) and/or non-volatile (such as read-only memory (ROM), flash memory, etc.). In some embodiments, the memory devices may include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the devices. In some implementations, the memory includes multiple different types of memory, such as static random-access memory (SRAM), dynamic random access memory (DRAM), or ROM.

The memory, the removable storage, and the non-removable storage are all examples of computer-readable storage media. For example, computer-readable storage media may include volatile and non-volatile, removable and non-removable media implemented in any method or technology for storage of information such as computer-readable instructions, data structures, program modules or other data. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tapes, magnetic disk storage or other magnetic storage devices, or any other medium which may be used to store the desired information and which may be accessed by the devices. Combinations of any of the above should also be included within the scope of computer-readable media.

The control subsystem can also include one or more communication connections that may allow a control device (not shown) to communicate with devices or equipment capable of communicating with the control subsystem. Connections may also be established via various data communication channels or ports, such as USB or COM ports to receive cables connecting the control subsystem to various other devices on a network. In one embodiment, the control subsystem can include Ethernet drivers that enable the control subsystem to communicate with other devices on the network. According to various embodiments, communication connections may be established via a wired and/or wireless connection on the network.

The operation of the apparatus will now be described. The sample is initially sealed in the chamber and pressurized gas is controllable delivered to the fully wetted surface of the sample. The pressure of the gas and the mass flow rate of the gas is selectively controlled throughout the testing process. As one will appreciate, the described dynamic methodology reduces the time required to determine the pore size and pore size distribution of the porous material sample while enhancing the resolution of the measurement.

In embodiments, the methodology can initially supply a linear pressure ramping approach until the bubble point to determine the bubble point. Optionally, the methodology can initially supply a pressure stepping and/or pressure ramping approach until the bubble point to determine the bubble point. In embodiments of the present invention, initially a fixed flow of gas is delivered to the testing chamber and the rate of pressure rise is measured to determine a first bubble point. In this aspect, a very low fixed flow rate can be used (10-100 sccm), to allow for ready determination of a drop in the rate of pressure rise drops when the first pores open, e.g., at the first bubble point. In one embodiment, the methodology can determine the first bubble point prior to beginning the full porometry scan.

In embodiments, the methodology uses pressure ramping to enable rapid measurements and combines it with a technique that exponentially slows the rate of the pressure ramp to approach a constant pressure as a function of gas flow rate change. Thus, in embodiments, pressure is ramped up via either a linear pressure ramping approach or a pressure stepping approach until the bubble point is determined, at which point the methodology deviates from a linear pressure ramping approach by dynamically and exponentially changing the linear slope of pressure change to slow the increase of the pressure ramp to approach a constant pressure as a function of gas flow rate change. At this constant pressure as a function of gas flow rate change point, data can be obtained that enables the determination of the porosity of the sample with high resolution. As one will appreciate, this method is designed to minimize test time while enhancing resolution in capillary flow porometry.

It is common in methods that pressurize sample chamber systems for any change in pressure to result in a charging flow that is directed to pressurizes the sample chamber volume. In an optional embodiment, it is contemplated that this charging flow is determined and is corrected for in the pressure ramping aspects of the described test methodology.

In alternative embodiments, it is contemplated that pressure can ramped up via either a linear pressure ramping approach or a pressure stepping approach until the bubble point is determined, at which point the methodology deviates from a linear pressure ramping approach by exponentially changing the linear slope of pressure change to slow the increase of the pressure ramp to approach a constant pressure as a function of gas flow rate change. In further alternative embodiments, it is contemplated that pressure can ramped up via either a non-linear function ramping approach or an exponential pressure ramping approach until the bubble point is determined, at which point the methodology deviates from initial ramping approach by exponentially changing the linear slope of pressure change to slow the increase of the pressure ramp to approach a constant pressure as a function of gas flow rate change.

In an optional embodiment, a pseudo ramping mode approach can be applied when a linear pressure ramping approach is selected and the starting pressure is below a target pressure, which can be about 5 psig (35 kPag). In this aspect, the pseudo ramping mode approach operates like a pressure stepping approach that allows for more accurate measurements of pressure and flow when the pressure is below the target pressure. Further, the pseudo ramping mode approach can be configured to revert to a normal ramping mode approach when the applied pressure exceed the target pressure.

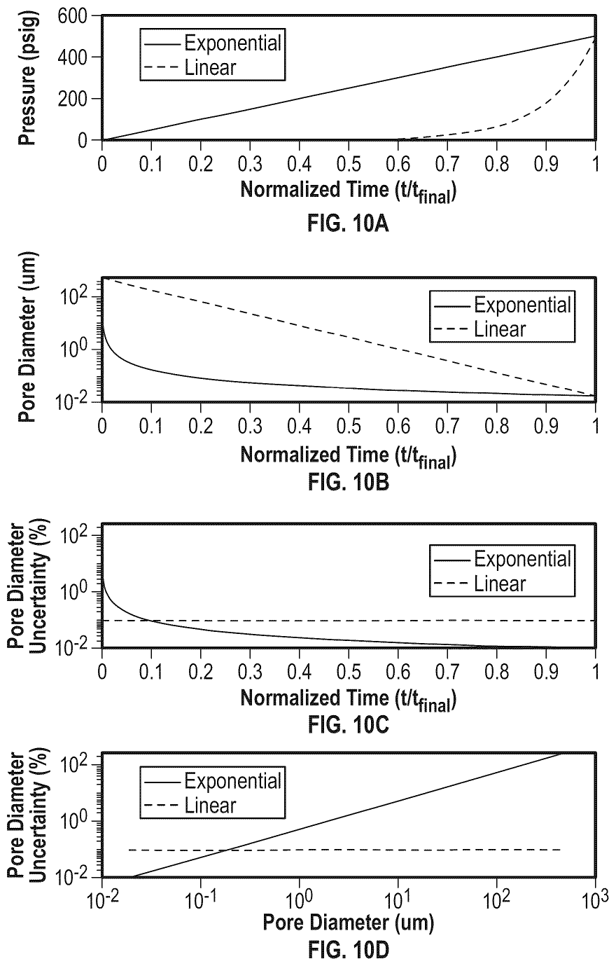

The methodology described herein dynamically adjusts the pressure ramping to maximize resolution during pore openings. That is, the method dynamically increases pressure ramp rate as rate of mass flow change decreases and dynamically decreases pressure ramp rate as rate of mass flow change increases. As shown in FIGS. 6 and 7, optionally, and to further enhance the resolution of the porosity measurements, user parameters can be applied to control the pressure ramp sensitivity to changes in mass flow rate, and a resolution parameter can be used to control the rate of pressure change.

In further optional aspects, the applied pressure rate can be dynamically adjusted based on a set of user adjustable parameters including a least one of a maximum pressure ramp rate, a resolution parameter that controls ramp rate deacceleration, and a sensitivity parameter that controls how sensitive the rate of pressure change is to changes in the gas flow rate.

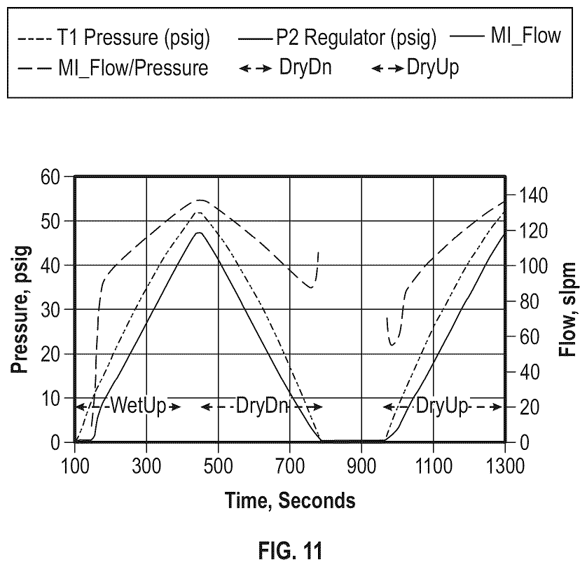

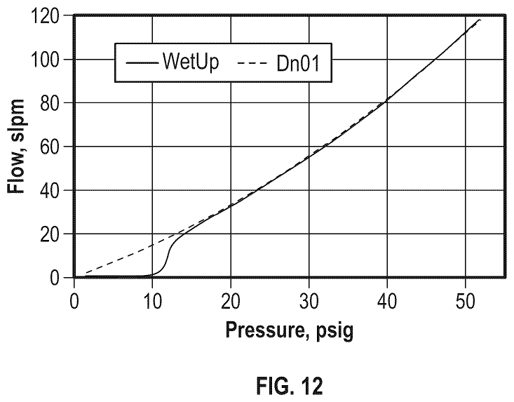

Referring to FIGS. 8 and 9, in an embodiment, an analytical method for determining pore size and pore size distribution of a porous material is provided using a viscous wetting fluid to pass through pores. In an embodiment, the apparatus can be selected for operation in either a high-productivity or a high-resolution mode. In embodiments of the high-productivity or high-resolution modes, the pressure rate of change for the gas supplied to the sample chamber can be dynamically controlled according to a function contained an exponential term. In embodiments, and as detailed below, the exponential term can include a percent mass flow rate per unit time through the sample material. For example, in the high-productivity mode, the exponential term/function can be chosen so that the pressure ramp up is at a rapid rate while percentage mass flow change per unit time through the sample material is small, with the pressure rate of change increasing toward a maximum allowed pressure rate of change until the bubble point is reached, then the pressure rate of change can be dynamically adjusted (e.g., decreased), in accordance with an exponential factor based on a percent change in mass flow rate per unit time. As one will appreciate, as the flow rate through the sample material increases, the pressure rate of change of flow rate can approach zero. In the high-resolution mode, the function/exponential factor can be chosen such that the pressure rate of change is ramped up at a slower rate until the bubble point, and then can be dynamically adjusted so as to be held at almost zero during opening of pores throughout the sample.

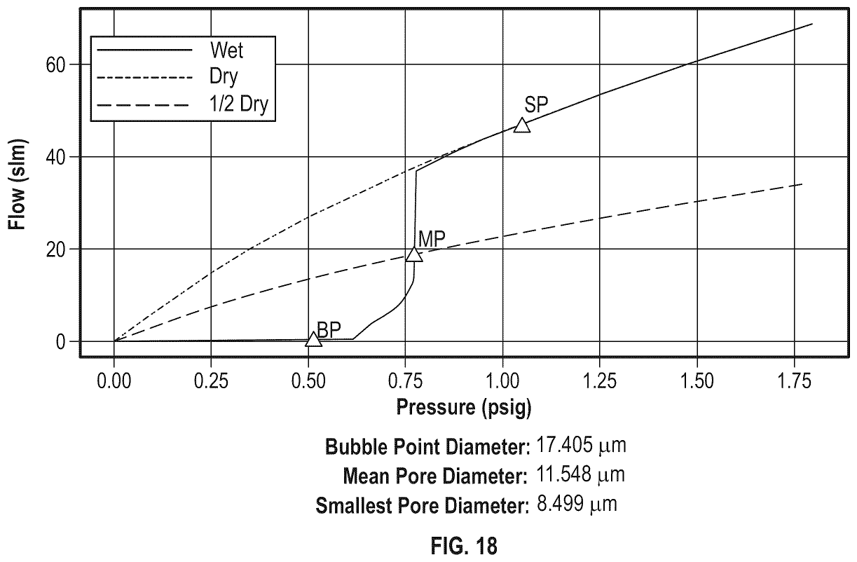

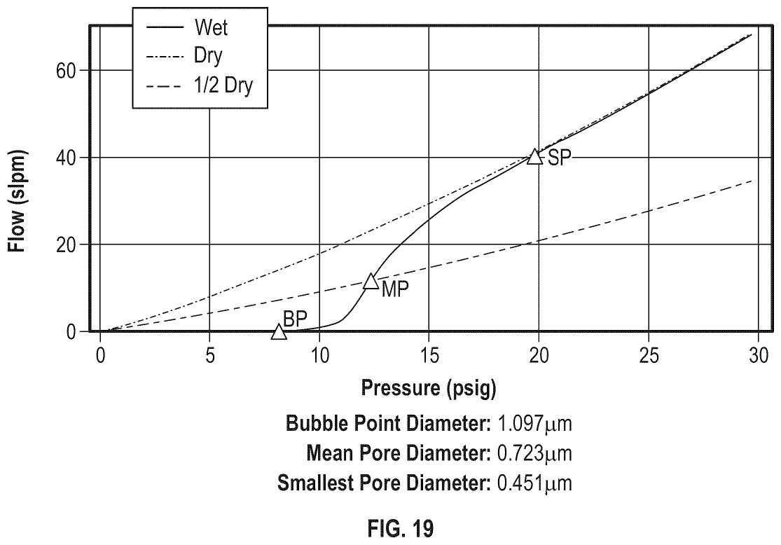

Referring to FIG. 8, the relationship between flow rate and pressure increases over time is graphically represented. As shown in the figure, when the bubble point is reached, the method of the present invention preferably decreases the rate of pressure increase dramatically. As one will appreciate, once the testing modality reaches mean pore diameter the rate of flow change increases at a rapid rate. Because of this rapid rate of flow change it is desirable to obtain additional resolution around the flow rate changes that occur about the mean pore diameter of the sample. Thus, one step in the methodology of the invention seeks to decrease the pressure ramp rate in the area of desired heightened resolution at an exponential rate as a result of a sensed increase in the rate of flow—this is in contrast to the conventional linear ramp rate methodology. Another step in the methodology seeks to exponentially increase the pressure ramp rate as the sensed rate of flow decreases. This cycle of exponentially decreasing the pressure ramp rate as the sensed rate of flow increases and conversely exponentially increasing the pressure ramp rate as the sensed rate of flow decreases can continue to discover high resolution data for testing samples that include pores of varying diameter. As shown in FIG. 8, because the testing sample is a one micron standard filter with uniform pores of about one micron, there is only a single cycle demonstrating the exponential decrease/increase in the pressure ramp rate as the sensed flow of fluid respectfully increases/decreases. Thus, for samples having varying pore sizes, and as shown in FIG. 16, it would be anticipated that such a graphical representation would include multiple such cycles that are each representative of pore of a particular size. In exemplary aspects, FIG. 15 also demonstrate two pressure regions in which the dynamic adjustment in pressure ramp rate allows for improvement of resolution about the two exemplified pore sizes.

As shown in FIG. 9, applying cycle(s) of exponentially decreasing the pressure ramp rate as the sensed rate of flow increases and conversely exponentially increasing the pressure ramp rate as the sensed rate of flow decreases allows for the detection of high resolution data for testing samples that can graphically demonstrate details of the pore size in the testing samples. Here, the change in flow rate divided by pressure is mapped against pore size and variations in pore size are demonstrated in detail.

In one example, the applied testing pressure ramp can be modified in an exponential form and can be controlled between a defined minimum and maximum pressure ramp rate. In this aspect, a maximum pressure ramp can be applied when rate of change of mass flow is constant and can approach zero when rate of change of mass flow increases.

In embodiments, an exemplary exponential high-resolution ramp function for use in this methodology is described below. The high resolution pressure ramp rate can be calculated by:

$$Pressure Ramp Rate = \frac{Max Linear Ramp Rate}{{e}^{[ \frac{dF}{dt} * {K}^{resolution sensitivity} ]}}$$

where:
   K is a constant;
   resolution is a parameter effecting resolution;
   sensitivity is a parameter effecting sensitivity; and

$$\frac{dF}{dt} = Rate of change of mass flow .$$

In this example, the numerator is a linear rate, and the denominator is the expression that slows the linear ramp rate as a function of change in flow. In this aspect, the function can be executed at a periodic rate and the resulting value represents the instantaneous pressure control setting. The data illustrated in FIGS. 9A-9B, 10A-10B, and 11-19 were derived using the linear ramp rate described above.

Optionally, a high resolution pressure ramp rate can replace the max linear ramp rate (the numerator in the previous function) with an exponential ramp rate. In this exemplary aspect, the high resolution pressure ramp rate can be calculated by:

$$Pressure Ramp Rate = \frac{{P}_{low} {e}^{{u}_{r} ft}}{{e}^{[ \frac{dF}{dt} * {K}^{resolution sensitivity} ]}}$$

where:
   P_{low} is;
   Ur is pore size uncertainty and is a constant;
   f is measurement sampling frequency and is a constant;
   K is a constant;
   resolution is a parameter effecting resolution;
   sensitivity is a parameter effecting sensitivity; and

$$\frac{dF}{dt} = Rate of change of mass flow .$$

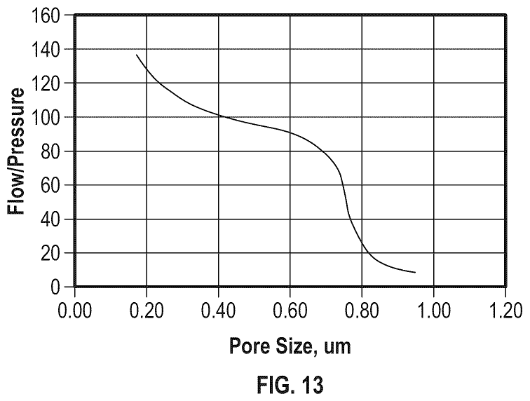

Referring to FIGS. 10A to 10D, it is noteworthy that conventional linear pressure ramping over time may be too “fast” for large pores in a sample while being conversely too “slow” for small pores in the same sample. As shown, dynamic and exponential pressure control of the present disclosure provides a faster overall determination of porosity and allows for substantially the same uncertainty (i.e., error in measurement divided by pore size) in each pore measurement across the entire range of pore sizes. The present methodology accomplishes this by taking smaller or larger steps in pressure where appropriate, for example, when measuring small pores, large pressure steps can be taken and when measuring large pores, small pressure steps can be taken.

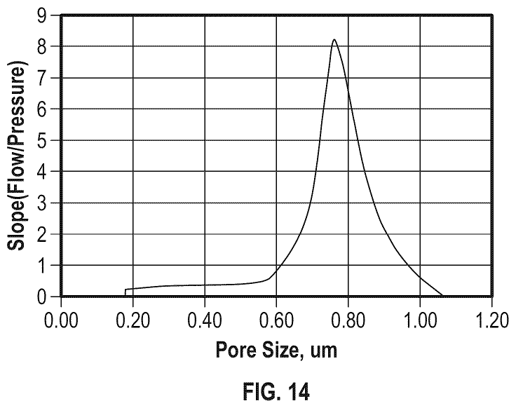

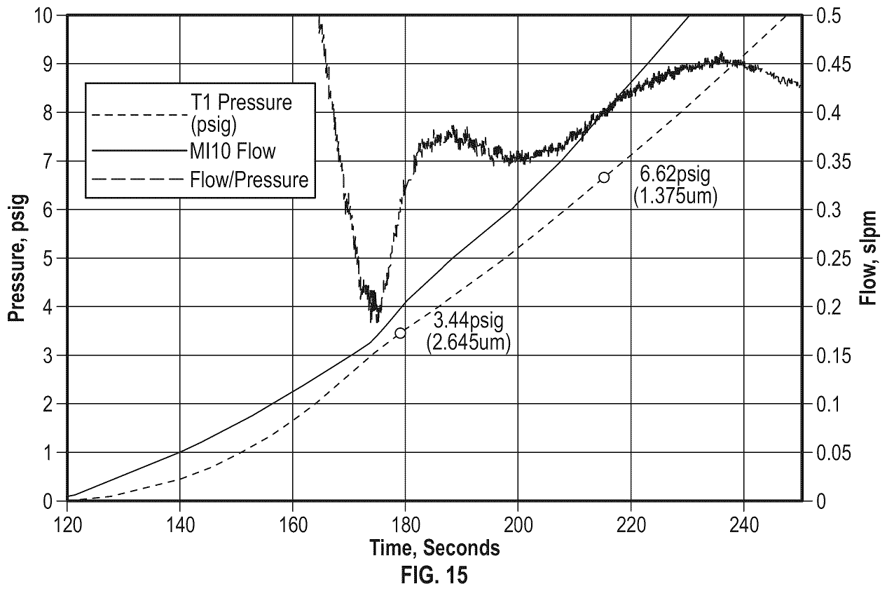

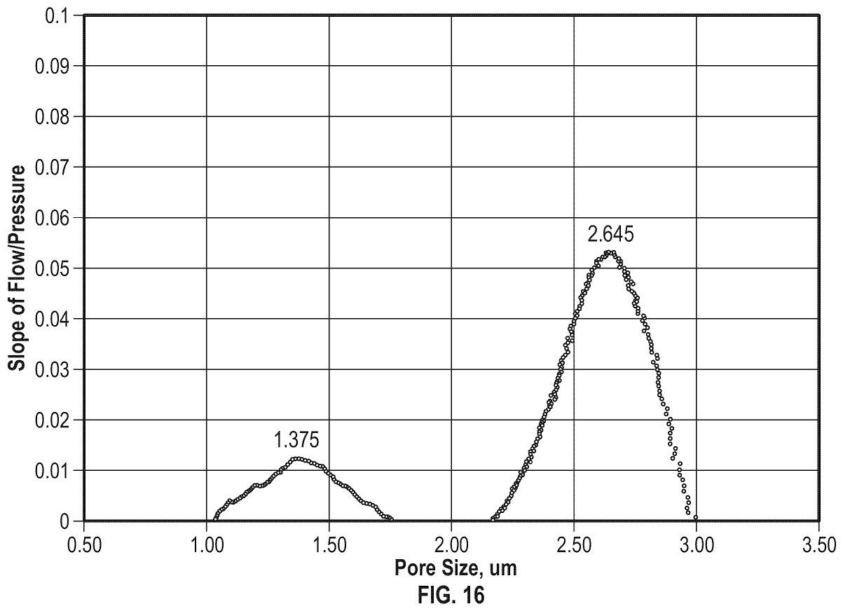

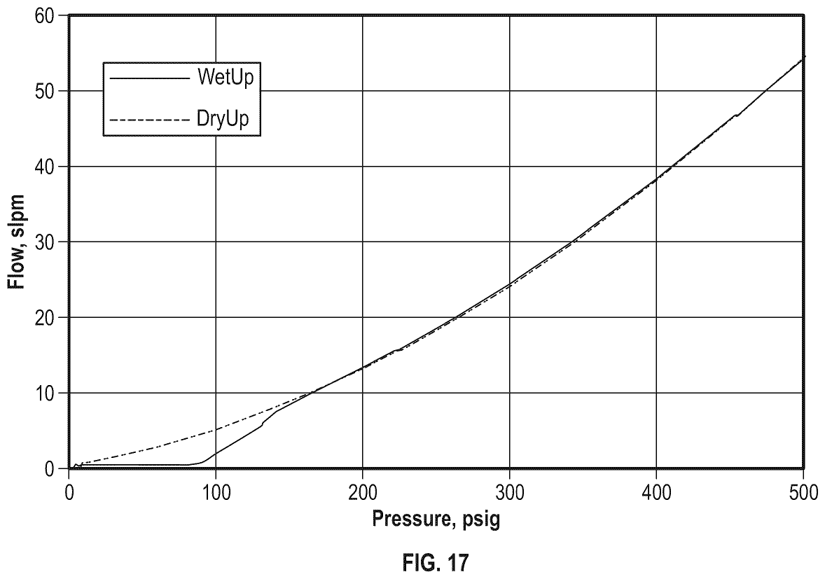

FIGS. 11-14 graphically illustrates the conversion of time series data results for an exemplary 1.0 μm thin filter sample using a 0.2 psi/second linear ramp modality into a slope vs pore size plot. FIG. 11 shows applied T1 pressure (psig), flow (slpm), and flow/pressure and further shows derived wet up, dry down, and dry up cycles. The data of FIG. 11 is converted into a flow versus pressure plot showing applied T1 pressure (psig), flow (slpm), and flow/pressure in FIG. 12. Further, the data of FIG. 12 is converted into the flow/pressure versus pore size pressure plot shown in FIG. 13. Finally, the slope of a slope of the respective flow/pressure data points of FIG. 13 are plotted against the pore size data points in FIG. 14, which graphically shows the pore size of the sample gathered about a 0.76 μm pore size.

Similarly, FIGS. 15-16 graphically illustrates the conversion of time series data results for an exemplary filter sample having two discrete pore sizes using a 0.2 psi/second linear ramp modality into a slope vs pore size plot and shows applied T1 pressure (psig), flow (slpm), and flow/pressure. After the series of conversions described above, FIG. 16 shows the time series data of FIG. 15 converted into a slope vs pore size plot, in which the slope is the slope of the respective determined flow/pressure data points derived from FIG. 15, and graphically shows the pore sizes of the sample gathered about respective 1.375 and 2.645 μm pore sizes.

In an alternative embodiment, it is contemplated that the method of testing can be shortened without affecting the accuracy of the determined nominal pore size of the test filter sample. In this aspect, it is contemplated that upon recognition of the inflection point noted in flow versus pressure plot data results a factor N is subsequently applied, which would truncate the ramp up test protocol before the nominal time required to completely run the full underlying test protocol. In this aspect, it is contemplated that, for example, and without limitation, factor N can be about 2, about 3, or at least 3, which factor N can be selectively elected by the operator to insure accuracy of the truncated test protocol.

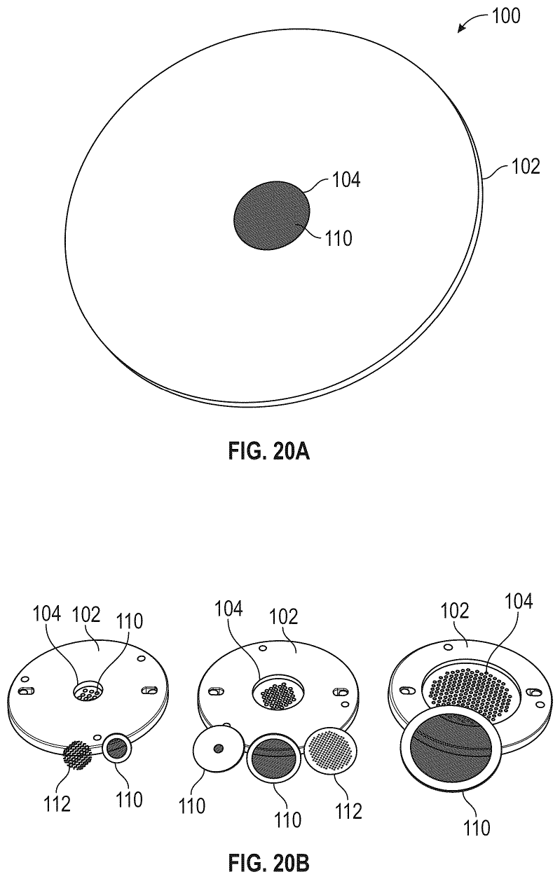

It is noteworthy, and referring now to FIG. 17, that upon the identification of the inflection point at approximately 150 psig, minimal data is subsequently obtained in the subsequently testing time in which flow and pressure and pressure are increased in accord with standard testing protocol. Thus, it would be contemplated, in this example, to apply a factor of 2, and to cease testing at approximately 300 psig (with a flow rate of approximately 24 slpm).

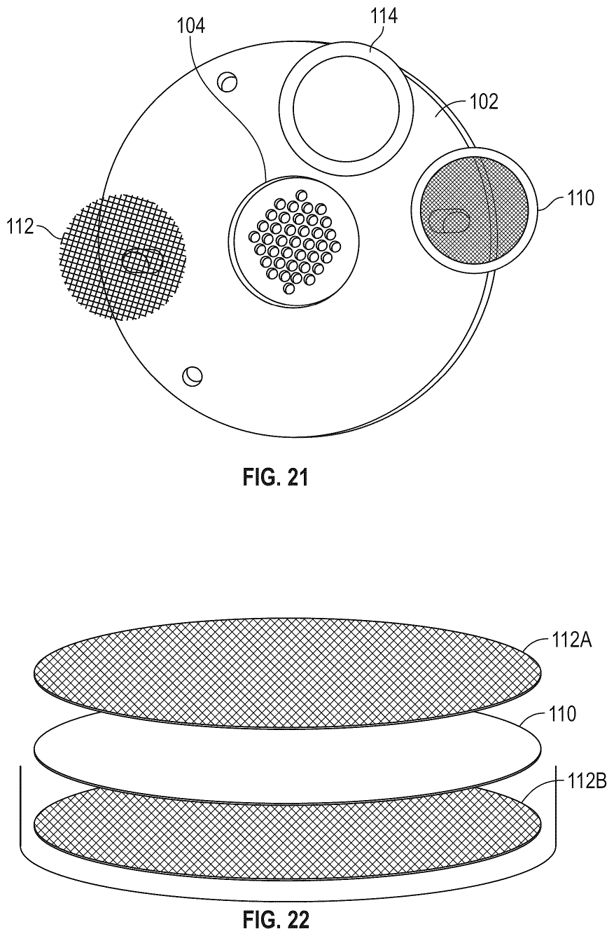

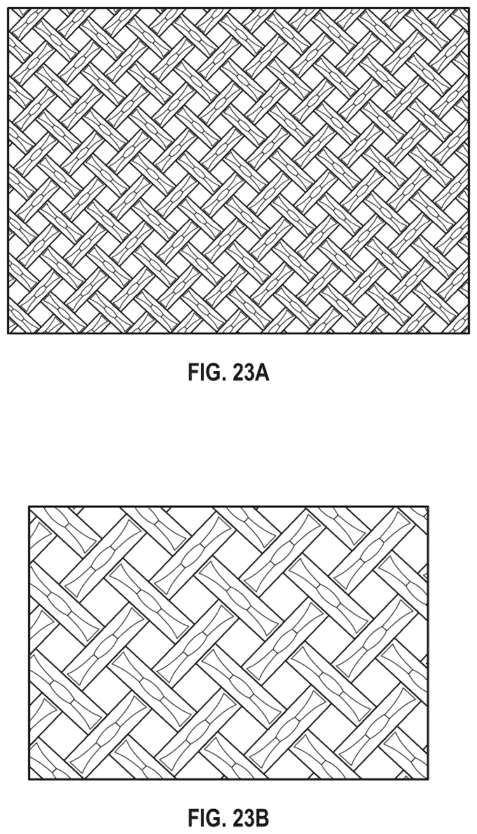

Similarly, FIGS. 18 and 19 graphically illustrates a flow versus pressure plot data results for thin filter samples having differing pore sizes. In FIG. 18, an exemplary 12.0 μm nominal pore size thin filter sample using a 0.2 psi/second linear ramp modality showing applied T1 pressure (psig), flow (slpm), and flow/pressure. Similarly, FIG. 19 graphically illustrates a flow versus pressure plot data results for an exemplary 1.0 μm nominal pore size thin filter sample using a 0.2 psi/second linear ramp modality showing applied T1 pressure (psig), flow (slpm), and flow/pressure. As shown, it is relatively easy to identify inflection points of test filter samples with relatively large nominal pore size (see FIG. 18) and in test filter samples with relatively small nominal pore size (see FIG. 19.

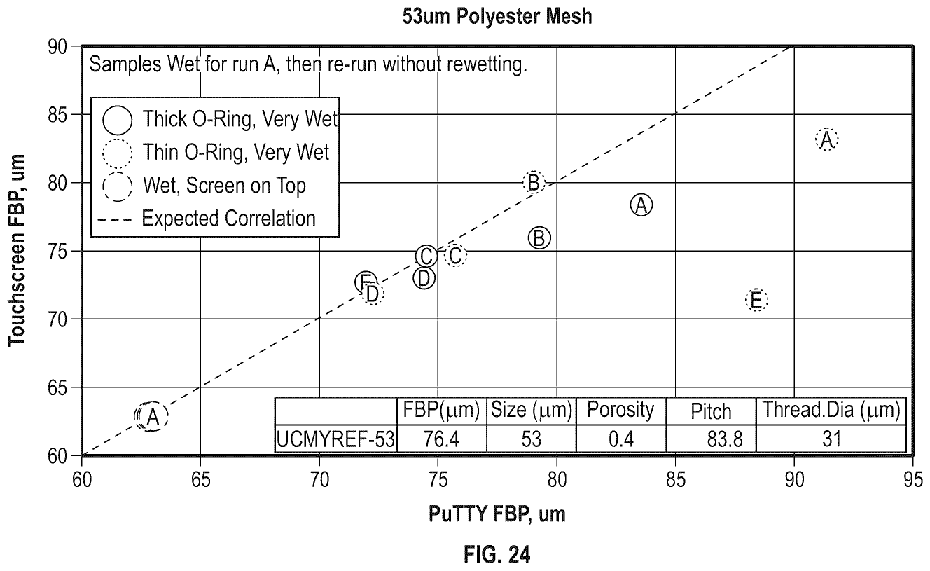

FIGS. 20A and 20B show embodiments of sample adaptor plates having a plate member configured with a central well that is operatively sized and shape to receive a porous test sample, such as the exemplarily shown woven test mesh filter samples. One will appreciate that such sample adaptor plates can be used in conventional porosity sample chambers using conventional pressure ramping and testing modalities as well as the dynamic testing systems and modalities descried herein. Typical sample test meshes have an outer diameter of 25 mm with a flow area that is proximate to the outer dimeter. Referring to FIG. 20A, an exemplary sample test mesh that has an outer diameter of 25 mm but only has an operative flow diameter of about 5 mm is presented. The reduced flow area of the exemplary sample test mesh provides an advantage as it is easier to apply the high pressure necessary to empty small pore sizes because flow is proportional to area. The larger outer diameter also advantageously provides an adequate upper surface of the sample test mesh for the application of the O-ring. The exemplified sample adaptor plate can be advantageously used to test small pore (high pressure) samples to achieve required high pressure while limiting flow.

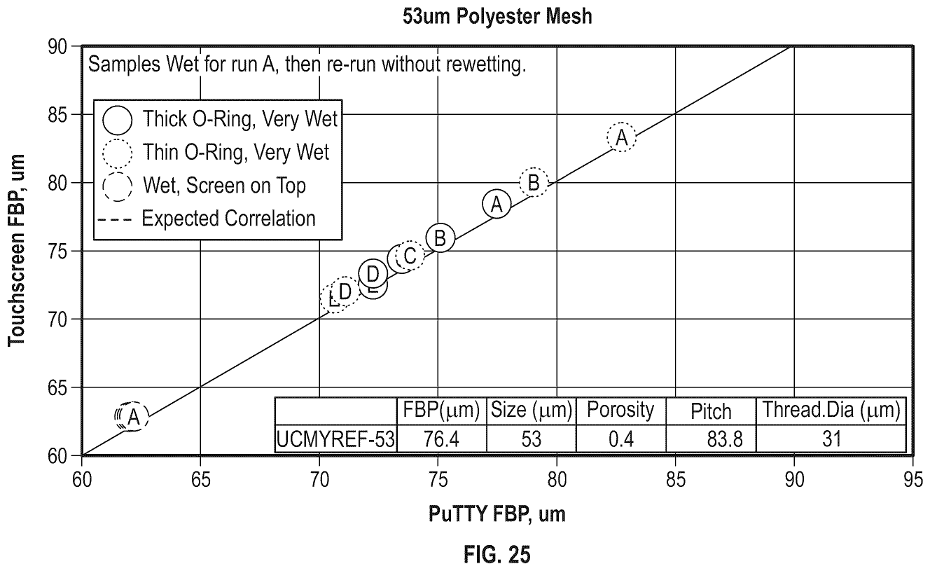

FIG. 21 shows an embodiment of a sample adapter plate showing a plate member for receipt of a filter sample. In embodiments, the exemplary plate member has a central well configured to operatively receive a woven test mesh filter sample positioned in stacked relationship to a lower fine mesh screen and an O-Ring to seal the well for testing. Also shown is an optional upper coarse screen that can be applied to an upper surface of a woven test mesh filter sample. In this optional aspect, and without limitation, the upper course screen can preferably be used when the mesh filter sample contains large pore samples (e.g., pores that are greater than about 100 μm) or as desired to improve Dry curve behavior.

One skilled in the art will appreciate that woven test mesh filter samples can be formed from interwoven polymer monofilament, such as, without limitation, polyester interwoven mesh filter samples and the like. Such interwoven mesh filter samples come in a variety of sizes specified by mesh opening size (u) and are suitable for applications in several industries. These interwoven mesh filters possesses excellent qualities such as corrosion and moisture resistance, durability and elasticity as the monofilament fibers, woven to tight tolerances, create a uniform pore size, exceptional strength and dimensional stability.

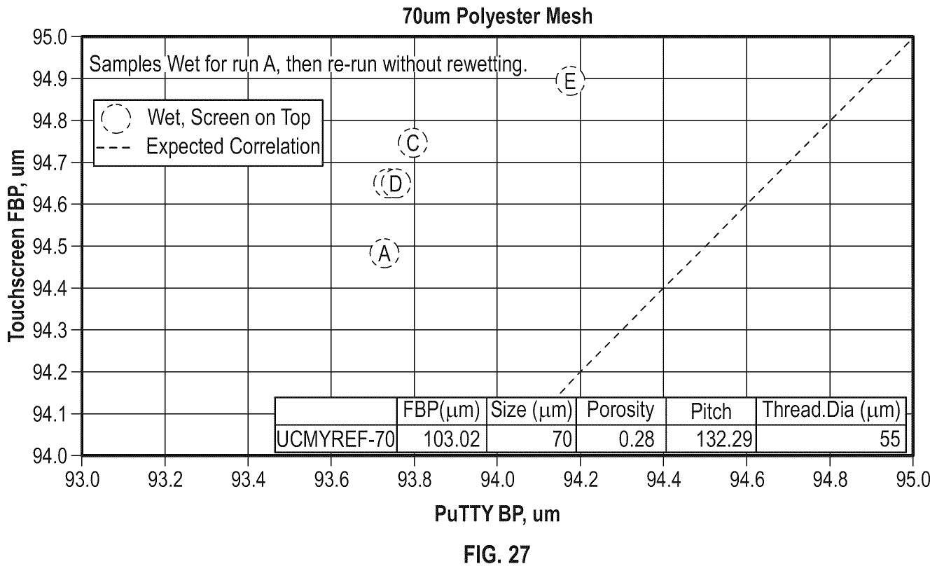

It is noteworthy however that conventional interwoven mesh filters can create gaps of increases porosity proximate areas in which the monofilaments overlie each other as the respective monofilaments are not physically connected together at the respective points of monofilament overlap (except for the forces nominally applied by respective monofilaments due to the interwoven nature of the formed interwoven mesh filter). These formed gaps can adversely affect the accuracy of the test results for formed interwoven mesh filter sample. FIGS. 23A and 23B show photomicrographs of exemplary woven test filter sample. FIG. 23A shows a photomicrograph of a 70 μm woven mesh filter (measured 65 μm) and FIG. 23B shows a photomicrograph of a 53 μm woven mesh filter (measured 50 μm).

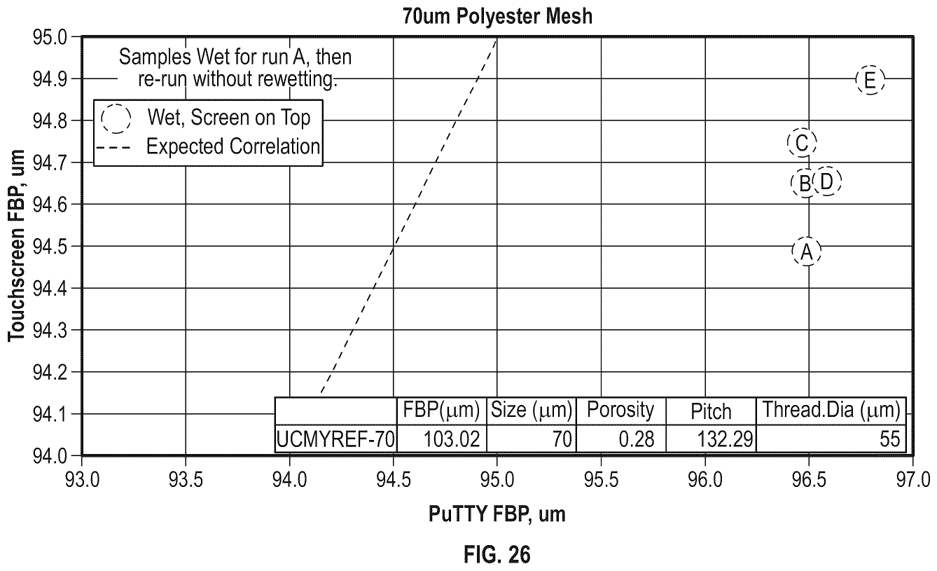

Thus, in a further aspect, an embodiment of a test stack profile for positioning therein the well of an adapter plate is shown in FIG. 22. In this embodiment, the test stack can comprise a woven test mesh filter sample that is configured to be positionable therebetween an upper fine mesh screen and a lower fine mesh screen. In operation, biasing means can be applied, such as by an O-Ring, to ensure that the formed test stack is placed into compression so that the fibers forming the woven test mesh filter sample are compressed together to form a test sample with a more uniform porosity.

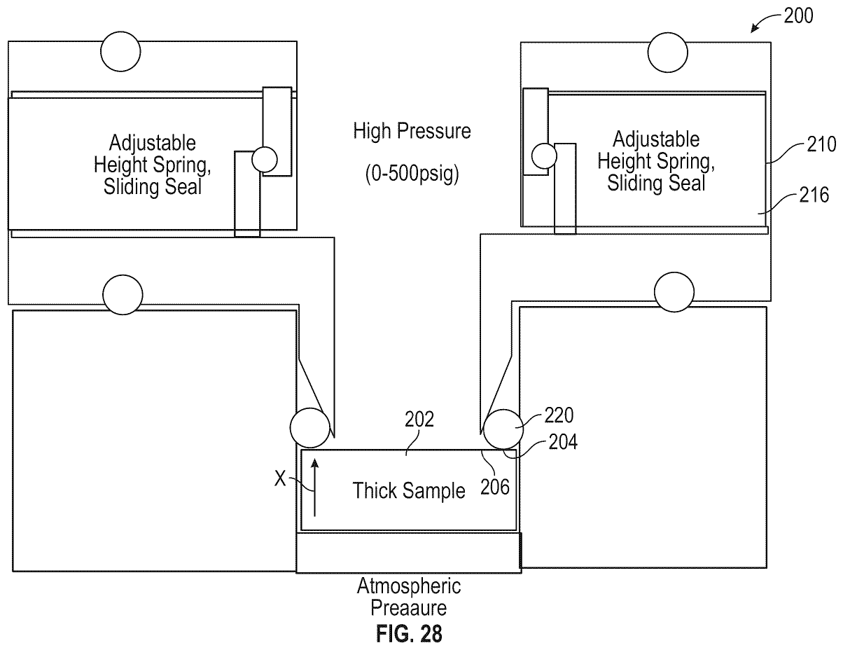

Referring now to FIGS. 24-27, a graphical illustrations of the results of testing of an exemplary test stack profile as shown in FIG. 22 are illustrated. In FIGS. 24 and 25 for example, a 53 μm woven test mesh filter sample was positioned between identical upper and lower fine mesh screens formed with (250 μm holes). As shown, the test was run multiple times with the wetted sample test “A” and multiple replicate runs (“B”, “C”, “D”, “E”) without rewetting. As shown by “A,” placing the exemplary test stack profile shown in FIG. 22 results in a significantly smaller FBP/BP, with excellent precision (0.1-0.2% RSD).

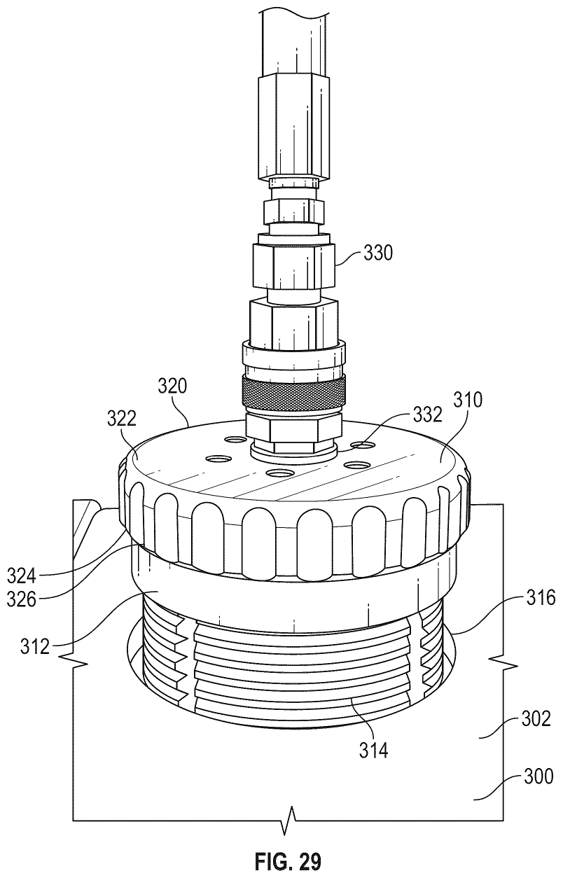

Similarly, and referring to FIGS. 26 and 27, graphical illustrations of the results of testing of an exemplary test stack profile formed as shown in FIG. 22 are presented. In this example, a 70 μm woven polyester test filter sample was positioned between identical upper and lower fine mesh screens formed with (250 μm holes). As shown, the test was run multiple times with the wetted sample test “A” and multiple replicate runs (“B”, “C”, “D”, “E”) without rewetting. As show, the test with 70 μm polyester mesh, with sample plates (250 μm holes) positioned above and below the test mesh filter showed tight grouping of FBP and BP (0.1-0.2% RSD). In addition, in the exemplary sample test, the bubble point pore size (average: 95.03 μm) was closer to that calculated from the thread diameter and pitch (103.02 μm) than to the nominal manufacturer pore size (70 μm).

In a further embodiment, it is contemplated that a testing filter sample can be used to calibrate the system, which testing filter sample can be used in conventional porosity sample chambers using conventional pressure ramping and testing modalities as well as the dynamic testing systems and modalities descried herein. In this aspect and without limitation, the testing filter sample can be configured to be received within the central well of a plate member. The testing filter sample can have a first plurality of pores having a minimum pore size and a second plurality of pores having a minimum pore size that is greater than the minimum pore size of the first plurality of pores.

It is contemplated in one embodiment, without limitation, that the first plurality of pores and the second plurality of pores can be laser micro-hole drilled. Optionally, it is contemplated in another embodiment, without limitation, that the testing filter sample can be formed from a track-etched membrane in which the first plurality of pores is defined therein. In this aspect, the second plurality of pores can be laser micro-hole drilled into the track-etched membrane.

For example, and without limitation, the first plurality of pores can have a minimum pore size of less than 2.0 μm, preferably the first plurality of pores can have a minimum pore size of less than 1.5 μm, more preferably the first plurality of pores can have a minimum pore size of less than 1.0 μm, and still more preferred the first plurality of pores can have a minimum pore size of less than 0.5 μm. For example, and without limitation, the second plurality of pores can have a minimum pore size of greater than 2.0 μm, preferably the second plurality of pores can have a minimum pore size of greater than 4.0 μm, and more preferably the second plurality of pores can have a minimum pore size of greater than 6.0 μm. In a further optional embodiment, without limitation, it is contemplated that each pore of the first plurality of pores has a minimum pore size of less than 2.0 μm and each pore of the second plurality of pores has a minimum pore size of greater than 2.0 μm.

Further, it is contemplated that the size of pores forming the first plurality of pores will exceed the size of pores forming the second plurality of pores by at least a factor of X. In this aspect, it is contemplated that X can be at least 2, at least 3, at least 5, or at least 10. Further, it is contemplated that the number of pores forming the first plurality of pores will exceed the number of pores forming the second plurality of pores by at least a factor of Y. In this aspect, it is contemplated that Y can be at least 10, at least, 25, at least 50, or at least 100. It is further contemplated that the first and second plurality of pores will be arranged in respective arrays in which the respective first and second plurality of pores are spaced for adjacent like pores at a uniform distance.

In an optional embodiment, the testing filter sample can further define at least one different pore that can be laser micro-hole drilled into the track-etched membrane. In this aspect, the respective pore size of the at least one different pore and its respective position can be operator specified. In a further aspect, it is contemplated that the at least one different pore can have a pore size that differs from the pore sizes of the respective first and second plurality of pores.

Operationally, testing the formed testing filter sample could be used to create flow versus pressure plot data that would identify two separate nominal pore sizes, the smaller pore size identifying the nominal pore size of the first plurality of pores and the second nominal pore size identifying the nominal pore size of the second plurality of pores. Thus, the testing filter sample could be used for operative training on the use or the system as well as ongoing calibration verification of the results of the system.

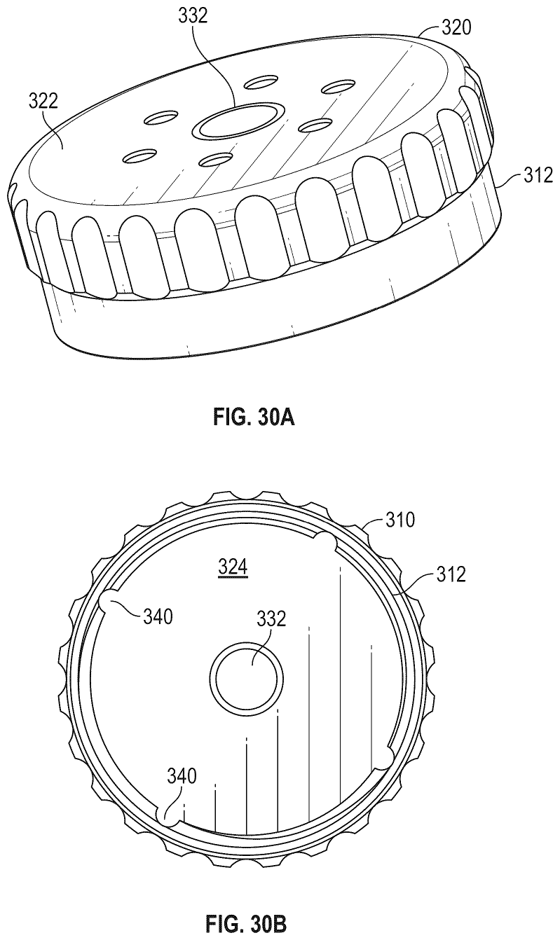

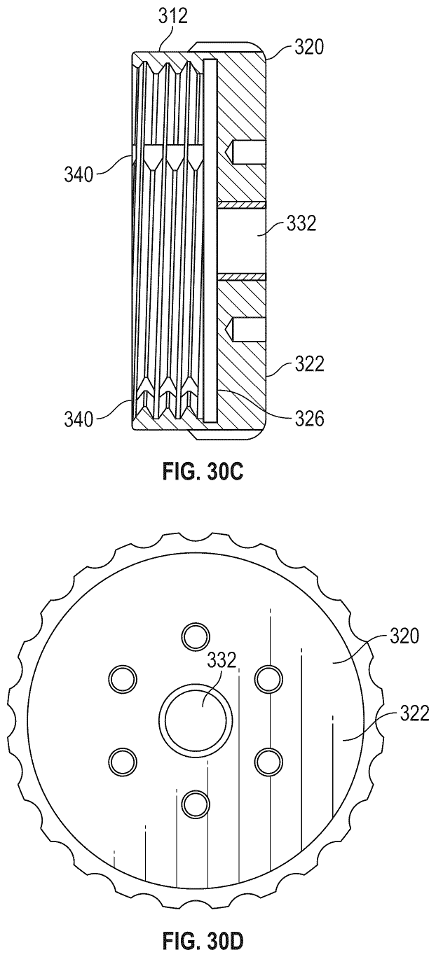

In one embodiment and referring to FIG. 28, a sample adjustable sample plate assembly 200 can be provided that is configured to receive a test filter sample 202 that has a relatively thick height (t). Such a sample adjustable sample plate assembly 200 testing filter sample can be used in conventional porosity sample chambers using conventional pressure ramping and testing modalities as well as the dynamic testing systems and modalities descried herein. Conventionally, relatively thick filter samples (e.g., samples having a cross-sectional thickness t of at least 2 mm, at least 4 mm, at least 6 mm, at least 8 mm, or at least 10 mm) are difficult to test as an appropriate spacer is difficult to size that ensures appropriate compression of an O-ring 220 against the peripheral edge 204 of the upper surface 206 of the test filter sample without damaging the test sample (resulting from too high of an applied compressive force) or allowing leakage past the O-ring during the high-pressure portion of a test run. In this embodiment, it is contemplated to use an articulating or sliding seal assembly 210 that is configured to assert a desired degree of bias pressure thereon the O-ring 220 to assure proper operative seating of the O-Ring against the peripheral edge 204 of the test filter sample that is seated within the test well 212 of the sample plate assembly. In one aspect, the articulating or sliding seal assembly 210 can include a dial-in or screw-type assembly 214 that is configured to apply the desired degree of biasing force thereon the O-ring 220. Optionally, and as shown in FIG. 29, the articulating or sliding seal assembly 210 can include an auto-adjustable spring or similar compression based system 216 that is configured to apply the desired degree of biasing force thereon the O-ring.

In one embodiment and referring to FIG. 29, the inlet side 302 of the test chamber 300 can have a pressure-relief safety cap 310 that is configured to allow an operator to open the safety cap 310 while the chamber 300 is pressurized to allow for safe pressure release from the interior of the chamber 300. Such an exemplary pressure-relief pressure cap can be configured for use with conventional porosity sample chambers using conventional pressure ramping and testing modalities as well as the dynamic testing systems and modalities descried herein. In embodiments, the pressure-relief safety cap 310 has a circumferential wall 312 that is configured to be threadedly coupled to a complementarily threaded circumferential wall 314 in a throat 316, which is in fluid communication with an interior volume 301 of the sample chamber 300 into which the wetted pore sample can be mounted for testing. The cap 310 has a top member 320 having an upper surface 322 and a lower surface 324. As shown, the circumferential wall 312 is connected to the lower surface 324 of the top member 320 proximate the circumferential edge 326 of the top member and extends distally therefrom substantially transverse to a plane of the top member.

As shown, the first flow line 330 is coupled to an inlet port 332 defined on the upper surface 332 of the top member of the cap. In operation, it will be appreciated that the threadedly coupled cap/throat will be under increasing pressure as the pressure within the interior volume is increased over the course of the testing methodologies described herein. As one will appreciate, in operation, an upper edge surface 317 of the throat 316 will be in sealing engagement with portion of the lower surface 234 of the top member 320 of the cap when the cap is fully threaded onto the complementary throat into a sealed position.

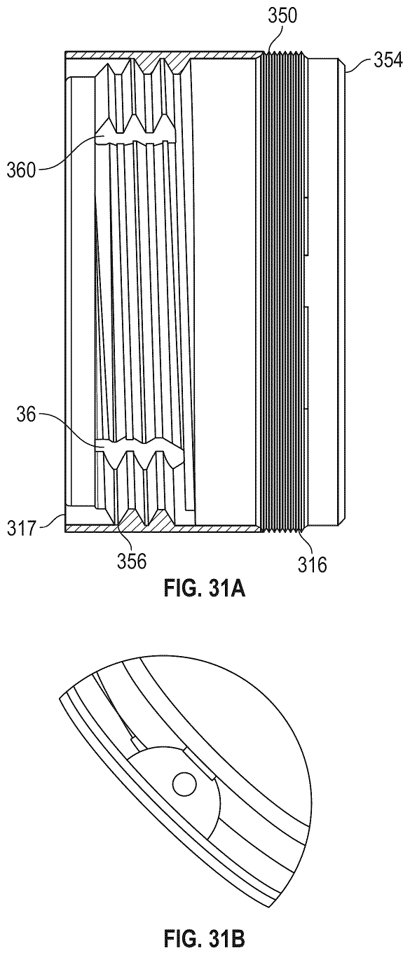

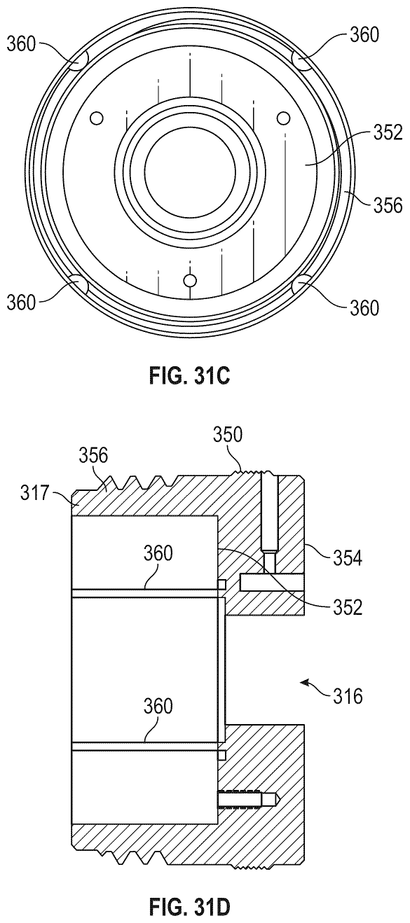

In embodiments and as shown in FIGS. 30A-30D and 31A-31D, it is contemplated that the cap 310 can define at least one cap grove 340 that extends from a distal edge of the threaded portion of the cap to proximate the lower surface of the top member. As shown, the at least one cap groove 340 is spaced from the termination of the thread near the lower surface of the top member. The at least one cap groove 340 extends transverse to the plane of the top member and can extend inwardly the depth of the tread of the cap. For example, and without limitation, the at least one cap groove 340 can have a half circle shape, a V-shape, a U-shape, and the like.

In one exemplified embodiment, the at least one cap groove 340 comprises a plurality of cap grooves 340 that can be spaced equidistant from each other. Still further, in one exemplary non-limiting example, the plurality of cap grooves 340 can comprise four spaced cap grooves.

In embodiments, it is contemplated that the throat 316 can have a bottom member 350 having a top surface 352 and a bottom surface 354. As shown, the circumferential wall 356 of the bottom member extends from the top surface of the bottom member proximate the circumferential edge 351 of the bottom member and extends distally therefrom substantially transverse to a plane of the bottom member. As shown, the throat 316 can define at least one throat groove 360 that extends from a proximal edge of the threaded circumferential wall portion of the throat to proximate the top surface of the bottom member. As shown, the at least one throat groove 360 is spaced from the termination of the thread near the top surface of the bottom member. The at least one throat groove 360 extends transverse to the plane of the bottom member and can extend inwardly the depth of the tread of the thread. For example, and without limitation, the at least one thread groove 360 can have a half circle shape, a V-shape, a U-shape, and the like.

In embodiments, the cap 310 and the throat 316 have equal numbers of respective at least one cap grooves 340 and at least one throat grooves 360. Further, it is contemplated that if the cap and the throat each have a respective plurality of gap grooves and a plurality of throat grooves, the spacing between the respective plurality of gap grooves and a plurality of throat grooves can be equidistant such that the respective plurality of gap grooves and a plurality of throat grooves can be positioned in overlying relationship with each other to allow for the selective formation of a plurality of flow conduits.

In operation, upon selective rotation of the cap 310 relative to the throat 316 from the sealed position, the cap 310 can be angularly rotated until the least one cap grooves 340 and at least one throat grooves 360 (the respective plurality of gap grooves and a plurality of throat grooves) are positioned into overlying relationship. In this position, the cap groove(s) and the throat groove(s) form a fluid conduit that is in fluid communication with the pressurized interior volume of the sample chamber and the atmosphere while resisting separation of the cap from the throat due to the still threaded positioning of the cap and the throat. Further in this position, fluid passing through the formed fluid conduit can generate a tone to notify the operator that fluid is escaping the sample chamber.

The foregoing has described various embodiments of a porometry analysis device and the disclosed systems and methods are provided to illustrate the essential and optional features and functions, and those skilled in the art may conceive of alternatives or modifications that do not depart from the principles of the invention as encompassed by the appended claims, and that such alternatives or modifications may be functionally equivalent.

What is claimed is:

1. An apparatus for dynamically determining the permeability of a porous solid, comprising:
a sample chamber defining an interior volume that includes a sample holder for holding a wetted porous solid sample, wherein the interior volume of the sample chamber defines an inlet side and an outlet side, which sides are separated by the sample holder, wherein the outlet side is in fluid communication with the atmosphere;
a first flow line in fluid communication with the interior volume of the inlet side of the sample chamber;
at least one gas source in fluid communication with the first flow line;
at least one pressure measuring device configured to sense the pressure of gas supplied to the first flow line;
at least one mass flow meter configured to sense the mass flow rate of pressurized gas supplied to the first flow line; and
a control subsystem comprising a processor in communication with the at least one pressure measuring device and with the at least mass flow meter, wherein the processor, in response to sensed gas pressure and the sensed mass flow rates of the supplied pressurized gas flow, selectively regulates the pressure of the gas being supplied to the porous solid sample positioned within the sample chamber and the mass flow rate of gas being supplied as a pressurized flow of gas to the porous solid sample to maintain control of the pressure of the gas and the mass flow rates in accord with a testing protocol pressure ramp, and wherein the processor, in response to sensed increase in the mass flow of pressurized gas, dynamically regulates a pressure ramp rate of the gas being supplied to the porous solid sample to exponentially increase the pressure ramp rate to increase resolution of the determination of the size of the pores in the wetted porous sample.

2. The apparatus of claim 1, wherein the processor, in response to sensed decrease in the mass flow of pressurized gas, dynamically regulates the pressure ramp rate of the gas being supplied to the porous solid sample to exponentially increase the pressure ramp rate to increase resolution to exponentially increase the pressure ramp rate as the sensed rate of flow decreases.

3. The apparatus of claim 1, wherein the testing protocol pressure ramp comprises a linear pressure ramping protocol until a bubble point of the wetted porous solid sample is reached, and wherein the processor, upon determination that the bubble point has been reached, deviates from the linear pressure ramping protocol by dynamically changing the linear slope of pressure change to exponentially slow the increase of the pressure ramp to approach a constant pressure as a function of gas flow rate change.

4. The apparatus of claim 3, wherein the processor is configured to dynamically increase the pressure ramp rate as a rate of mass flow change decreases and dynamically decrease the pressure ramp rate as the rate of mass flow change increases.

5. The apparatus of claim 3, wherein the processor applies a set of user adjustable parameters to control the pressure ramp sensitivity to changes in mass flow rate and a resolution parameter to control the rate of pressure change.

6. The apparatus of claim 4, wherein the processor further dynamically adjusts an applied pressure rate based on a set of user adjustable parameters that comprises at least one of a maximum pressure ramp rate, a resolution parameter that controls ramp rate deacceleration, and a sensitivity parameter that controls how sensitive the rate of pressure change is to changes in the gas flow rate.

7. The apparatus of claim 1, wherein the testing protocol pressure ramp comprises a pressure stepping ramping protocol until a bubble point of the wetted porous solid sample is reached, and wherein the processor, upon determination that the bubble point has been reached, deviates from the pressure stepping ramping protocol by dynamically changing the slope of pressure change to exponentially slow the increase of the pressure ramp to approach a constant pressure as a function of gas flow rate change.

8. The apparatus of claim 7, wherein the processor is configured to dynamically increase the pressure ramp rate as a rate of mass flow change decreases and dynamically decrease the pressure ramp rate as the rate of mass flow change increases.

9. The apparatus of claim 7, wherein the processor applies a set of user adjustable parameters to control the pressure ramp sensitivity to changes in mass flow rate and a resolution parameter to control the rate of pressure change.

10. The apparatus of claim 9, wherein the processor further dynamically adjusts an applied pressure rate based on a set of user adjustable parameters that comprises at least one of a maximum pressure ramp rate, a resolution parameter that controls ramp rate deacceleration, and a sensitivity parameter that controls how sensitive the rate of pressure change is to changes in the gas flow rate.

11. The apparatus of claim 2, wherein the testing protocol pressure ramp allows for pressure to ramp up at a rapid rate while percentage mass flow change per unit time through the wetted porous solid sample is small, with the pressure rate of change increasing toward a maximum allowed pressure rate of change until a bubble point is reached, subsequently the pressure rate of change is dynamically decreased, in accordance with an exponential factor based on a percent change in mass flow rate per unit time.

12. The apparatus of claim 11, wherein, the exponential factor is selectable such that the pressure rate of change is ramped up at a slower rate until the bubble point is reached and subsequently is dynamically adjusted so as to be held at almost zero during opening of pores throughout the wetted porous solid sample.

13. The apparatus of claim 1, wherein the processor, upon determination that a bubble point has been reached, to apply a user selected factor N to determine a test stop time point that is less than the total nominal time of a complete test protocol.

14. The apparatus of claim 13, wherein the factor N is at least 2.

15. The apparatus of claim 1, wherein the sample member comprises an adaptor plate having a plate member configured with a central well that is operatively sized and shape to receive the wetted porous solid sample.

16. The apparatus of claim 15, wherein the plate member has a first, outer diameter, wherein the central well has a second diameter that is less than the first, outer diameter.

17. The apparatus of claim 16, wherein the wetted porous solid sample comprises a woven mesh filter sample.

18. The apparatus of claim 17, wherein the woven mesh filter sample is positioned in stacked relationship to overlie a lower mesh screen, further comprising a biasing means applied to a portion of an upper surface of the woven mesh filter sample and configured to seal the woven mesh filter sample within the central well.

19. The apparatus of claim 17, wherein the woven mesh filter sample is positioned in stacked relationship to underlie an upper mesh screen and to overlie a lower mesh screen, further comprising a biasing means applied to a portion of an upper surface of the upper mesh screen and configured to seal the woven mesh filter sample within the central well.

20. The apparatus of claim 15, wherein the wetted porous solid sample comprises a testing filter sample, wherein the testing filter sample has a first plurality of pores having a minimum pore size and a second plurality of pores having a minimum pore size that is greater than the minimum pore size of the first plurality of pores.

21. The apparatus of claim 20, wherein each pore of the first plurality of pores has a minimum pore size of less than 2.0 μm, and wherein each pore of the second plurality of pores has a minimum pore size of greater than 2.0 μm.

22. The apparatus of claim 20, wherein the number of pores forming the first plurality of pores will exceed the number of pores forming the second plurality of pores by at least a factor of Y.

23. The apparatus of claim 22, wherein the factor of Y is at least 10.

24. A method for determining the permeability of a porous solid, comprising:
mounting a wetted porous solid sample within an interior volume of the sample chamber;
selectively regulating the pressure of the gas being supplied to the porous solid sample positioned within the sample chamber and the mass flow rate of gas being supplied as a pressurized flow of gas to the porous solid sample to maintain control of the pressure of the gas and the mass flow rates in accord with a testing protocol pressure ramp; and
dynamically regulating, in response to sensed increase in the mass flow of pressurized gas, a pressure ramp rate of the gas being supplied to the porous solid sample to exponentially increase the pressure ramp rate to increase resolution of the determination of the size of the pores in the wetted porous sample.

25. The method of claim 24, further comprising dynamically regulating, in response to sensed decrease in the mass flow of pressurized gas, the pressure ramp rate of the gas being supplied to the porous solid sample to exponentially increase the pressure ramp rate to increase resolution to exponentially increase the pressure ramp rate as the sensed rate of flow decreases.

26. The method of claim 24, further comprising applying a linear pressure ramping protocol until a bubble point of the wetted porous solid sample is reached and deviating from the linear pressure ramping protocol upon reaching the bubble point by dynamically changing the linear slope of pressure change to exponentially slow the increase of the pressure ramp to approach a constant pressure as a function of gas flow rate change.

27. The method of claim 24, further comprising applying, a pressure stepping ramping protocol until a bubble point of the wetted porous solid sample is reached and deviating from the pressure stepping ramping protocol upon reaching the bubble point by dynamically changing the slope of pressure change to exponentially slow the increase of the pressure ramp to approach a constant pressure as a function of gas flow rate change.

28. The method of claim 24, further comprising, when a bubble point is reached, dynamically decreasing the pressure rate of change in accordance with an exponential factor based on a percent change in mass flow rate per unit time.

29. The method of claim 28, wherein the exponential factor is selectable such that the pressure rate of change is ramped up at a slower rate until the bubble point and then is dynamically adjusted so as to be held at almost zero during opening of pores throughout the wetted porous solid sample.
